(19) United States
(12) Patent Application Publication
(10) Pub. No.: US 2004/0230519 A1
(43) Pub. Date: Nov. 18, 2004

(54) Weather insurance/derivative pricing model and method of generating same

(76) Inventor: Daniel J. Parker, Alpharetta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/862,740

(22) Filed: Jun. 7, 2004

Related U.S. Application Data
(63) Continuation-in-part of application No. 10/315,762, filed on Dec. 10, 2002.
(60) Provisional application No. 60/344,584, filed on Dec. 28, 2001.

(51) Int. Cl. G06F 17/60

(52) U.S. Cl. 705/37; 705/40

(57) ABSTRACT

A model and method for pricing, procuring, negotiating or transferring weather insurance policies, contracts and derivatives. The model includes bilateral or multilateral pricing and transfer of weather risk and is comprised of weather data transformed utilizing extraction of historical weather data, including weather measures, such as precipitation, wind speed, temperature and sunshine hours, subsequently providing the data to a database, operating on the values in the database utilizing a computer and software, and transforming the result into a pricing schedule. The model utilizes deviations from actual weather measures versus normal, average or predicted measures. The weather data may include high, low, actual, median or average values covering a selected period or point in time for weather conditions including temperature, wind speed and precipitation, or a tradable index and method for weather futures, comprised of weather data transformed, into an index which is tradable in the financial, weather derivative or insurance markets.

### CROSS-REFERENCES TO RELATED APPLICATIONS

This application is a continuation-in-part of Non-provisional Application No. 10/315,762, filed Dec. 10, 2002, entitled “Method and Apparatus for Generating a Weather Index”, which in turn claims the priority date and full benefit of Provisional Application No. 60/344,584, filed Dec. 28, 2001, entitled “Method and Apparatus for Generating a Weather Index”.

### COPYRIGHT NOTICE AND LIMITED AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The invention relates to the field of financial contract pricing models and methods. More specifically, embodiments of the present invention relate to a method and computerized apparatus for generating a pricing model for insurance policies, contracts and/or derivatives against weather deviations, based on departures from normal, average or otherwise-expected historical weather data conditions, to determine premium, rated value or consideration to grant coverage for a specific event time or longer periods.

### BACKGROUND OF THE INVENTION

Introduction

Weather insurance and weather derivatives are innovative tools utilized where there is a direct or indirect financial exposure to weather variations and/or extremes. Various individuals or companies utilize or carry insurance to meet their needs in times of loss, whether such insurance may be for a home, an automobile, their life or health, and so forth. Other financial risk may be hedged against by purchase of a financial instrument the value of which varies with a commodity, index or equity. Various companies exist to provide insurance products to cover the losses from adverse events. Some such companies are traditional insurance underwriters, while, more recently, other financial entities have become involved in insurance or other hedging methods. For example, including traditional insurers, there are now, risk acceptors, banks, hedge funds, and energy companies, wherein these entities accept and exchange policies, contracts and/or derivative agreements. Most notably in recent time, weather, and particularly its variability, has become a phenomenon to be insured against.

Weather risk coverage generally does not require an actual loss of property, financial status or other tangible loss. Thus, coverage and subsequent payouts are solely determined by the weather effect itself. Since no proof of loss is required to collect, each counterparty agrees to price the policy or derivative contract based upon the occurrence of a specified weather condition or group of conditions in a specified location or group of locations, during a specified time period or periods. Such policies or derivatives are sometimes synonymously referred to as “event-determined” or “time-determined” weather coverage. As an example of “event-determined” coverage, an entertainment group wanting to put on a concert might engage an outdoor stadium, wherein rain or some other specified weather condition could force cancellation of the concert or otherwise have an adverse effect on receipts for the concert. To protect itself from a catastrophic loss, such an entertainment group might wish to insure against the occurrence of a specified weather condition that would necessitate cancellation of the concert or otherwise adversely impact receipts for the concert.

Coverage might also be desired to insure against deviation of a specified weather condition at any of several geographic locations from a norm (historical value) of that weather condition at each respective location, during a specified extended period of time, such as, for exemplary purposes only, two days to a year or more. Such coverage for a deviation from a norm is referred to as “program” coverage. As an example of “program” coverage, manufacturers of certain equipment, for example, snow removal equipment, might wish to insure against general regional deviations from the weather norm during the winter, as a warm winter could adversely impact their seasonal sales of equipment.

Although there are methodologies that utilize deviation measurement of weather measures from a constant, such as the Heating Degree Day/Cooling Degree Day (HDD/CDD) method, which takes deviations from a fixed 65° F. benchmark, there are no methodologies that utilize deviations from a norm, such as from an average, or from an expected or predicted site(s) specific weather value.

In order to insure against weather variations, it is necessary to have an indicator that can be utilized to predict weather in order to accurately price a policy for weather deviation insurance coverage.

Generally, the concept of weather derivatives was pioneered in the USA as the energy sector was deregulated. Over the last two years market participation and diversity has grown. It is estimated that globally, roughly 7,500 transactions have been completed with approximately $12.5 billion in risk transferred between the counterparts to those trades. The use of weather derivative products goes far beyond the energy sector, as the agricultural, insurance, retail and leisure industries have realized the potential value of these products. As a measure of the potential size of the market, the US Dept. of Commerce has estimated that $2 trillion of the total $7 trillion US economy is subject to weather risk.

Since energy companies pioneered the weather derivatives market, the market has evolved around the requirements of such companies. Today, there does not exist a temperature and/or precipitation index, that is standard, universally accepted, or that flows perpetually with time at specified locations. There is no tradable index that participants could trade, and follow throughout the year without seasonal adjustment.

The Environomics program was established at the US government office of NCDC to enhance the understanding of weather and climate's effects on socioeconomic sectors of the United States. Climatic factors such as temperature, rainfall, snowfall, cloudiness and winds have a significant impact on many aspects of the nation's economy as well as human health and quality of life. Weather is often used to explain seasonal and year-to-year changes in economic performance; but, the explanations are often subjective and many times based on perceptions rather than clear observational evidence.

Ski resorts rely on cold temperatures and seasonal snow while families head for the beach on warm sunny days. Crop yields are higher when growing conditions are ideal. Housing and road construction progresses at a more rapid pace when temperatures are above minimum thresholds and conditions are dry. Energy usage is closely linked to seasonal temperatures so that demand for sources of energy such as natural gas, home heating oil and electricity increases during abnormally hot summers and extremely cold winters.

Through NCDC's Environomics program, climate indices are being developed to provide public and private sector analysts with up-to-date quantitative information on the effect of weather and climate on vital sectors of the U.S. economy and society. Although index development is ongoing, two indices currently provide valuable information related to crop yield and energy usage. The crop Moisture Stress Index reflects the influence of severe drought and catastrophic wetness on annual crop yield for corn and soybean crops, and the Residential Energy Demand Temperature Index provides quantitative information on the impact of seasonal temperatures on residential energy demand.

The indices were developed by NOAA's National Climatic Data Center (NCDC) in Asheville, NC, which maintains the world's largest weather database. The period of high-energy demand and prices of the late 1970's coincided with extremely cold winters that contributed to higher residential energy usage. The Residential Energy Demand Temperature Index (REDTI), which provides information related to climate sensitive residential energy demand, reflects this increased demand through historically high index values and can be used in part to explain the cause of the historically high energy demand of that time. By providing continuing updates to the index, a clearer understanding of future fluctuations in energy demand can be possible.

The REDTI tracks both unusually hot and unusually cold conditions. It varies from year to year due to variability and trends in temperature, and it responds most strongly to temperature conditions in heavily populated regions. REDTI values range from 0 to 100. Values greater than 90 indicate a much above average temperature-related energy demand and values less than 10 reflect much below average conditions.

While the REDTI provides information on the impacts of temperature on energy demand, the Moisture Stress Index (MSI), was developed to quantify the effect of soil moisture conditions on crop yield. It provides historical perspective on conditions such as moisture stress, that are closely associated with corn and soybean yields and is a source of information for explaining the cause of lower national yields. The REDTI index differs in that it measures subjective use of energy with fixed participation and reporting and is weighted to population and changes with census data.

Weather affects almost all types of businesses. A crop or dairy farmer's year could be ruined by an extended heat wave or cold snap, a drought, or excessive rainfall. The profits of amusement parks and ski areas likewise depend on long periods of the “right” kind of weather. But weather affects “indoor” businesses as well. For instance, sales of water, beer, soft drinks, air conditioners and bathing suits rise with temperature, but fall during cooler-than-usual summers. The U.S. Department of Commerce states that weather affects 70% of American companies, and as much as 22% of America's $9 trillion Gross Domestic Product (GDP).

Businesses hedge against economic losses with products based on interest rates, currencies and physical commodities. These products are called derivatives—because they are derived from the future price of the underlying commodity. Weather derivatives are no different. Weather derivatives use weather-related events as the underlying commodity, and are used to hedge against and control financial dependence on the weather. An unusual winter or extraordinary summer can drive costs higher and/or depress demand.

Weather derivatives are traded on exchanges, such as the Chicago Mercantile Exchange (CME) and London Financial Futures Exchange (LIFFE), as well as off-exchange or over-the-counter (OTC) between two or more derivative counterparts and via electronic exchanges. Broadly speaking, there are two widely utilized means by which derivatives are currently traded: (1) order-matching and (2) principal market making. Order matching is a model followed by exchanges such as the Chicago Mercantile Exchange and some newer online exchanges. In order matching, the exchange coordinates the activities of buyers and sellers so that “bids” to buy (i.e., demand) can be offset by “offers” to sell (i.e., supply). Orders may be matched both electronically and through the primary market making activities of the exchange members. Electronic platforms also known as Electronic Communication Networks (ECN) are the electronic network counterpart to the open outcry exchange.

In principal market-making, a bank, brokerage firm or trading desk/counterpart, for example, establishes a trading operation and makes a market by maintaining a portfolio of derivatives and underlying positions. The market maker usually hedges the portfolio on a dynamic basis by continually changing the composition of the portfolio as market conditions change. In general, the market maker strives to cover its cost of operation by collecting a bid-offer spread and through the scale economies obtained by simultaneously hedging a portfolio of positions.

Currently, the costs of trading weather derivatives (both on and off the exchanges) and transferring insurance risk are considered to be high for a number of reasons, including:

Liquidity

Many potential participants are unable to establish accounts due to credit relationships and financial capability. A weather-trading network may be as small as four counterparts, and, as such, bids and offers on the exchanges may be too wide for participants to take on risk, thus discouraging participation and limiting liquidity. Consequently, there is a need for an index that allows open entry based upon reasonable guidelines, thereby lowering the barrier of entry. There is currently no index that encourages vast participation from end users, businesses, hedge users, organizations, brokers and market makers.

Many newsworthy weather deals have been between two parties and never effected or presented into a liquid market. Although successful, these transactions were closed transactions among participants and, as such, did not contribute liquidity to a market. Therefore, there is a need for an index that promotes and encourages liquidity and competition within the weather derivatives market.

Transaction Costs

Due to the fact that most available derivatives are geared toward energy related measures, preparation of weather hedge strategies often requires a degree of customization. Moreover, costs of structuring a customized deal can take weeks to conclude and, as such, transactional cost can be high. As a result, there is a need for a streamlined process that avoids such high transactional costs. This is particularly true with derivatives where the costs of executing, and settling derivatives transactions can be large, sometimes requiring analytical and database software systems and personnel to procure such transactions. The direct market maker of weather deals almost always has superior information regarding the transaction than does the reinsurer or secondary market participant. Much like the market maker in capital markets, the reinsurer typically prices its informational disadvantage into the reinsurance premiums. Thus, there is a need for a tradable commodity that allows the costs of execution, procurement, and the added risk costs to be bypassed via direct access.

Event Risk

Many end user participants in the weather derivatives sector participate to protect a financial event or outcome. They sometimes purchase specialty insurance that covers risk of a certain event or gap. During periods of financial crises and disequilibria, it is common to observe dramatic volatility. The event risk of such crises and disequilibria is therefore customarily factored into derivatives prices by dealers, which increases the cost of derivatives in excess of the theoretical prices indicated by derivatives valuation models. These costs are usually spread across all derivative users. Accordingly, a driving force behind the costs of derivatives and insurance contracts is the necessity or desirability of risk management through dynamic hedging or contingent claim replication in a fashion that is continuous, liquid, and open to qualified participants.

The need of entities and individuals to make investments with the aim of gaining future returns is universal and well known. In general, investors look for opportunities to earn the highest possible returns from investments that fit within their individual risk profiles and with their other investment criteria, such as type and tradability of an investment vehicle, income potential and timing.

One major disadvantage is the lack of direct control that investors have over market conditions, inside information, and large orders. For example, it is difficult for investors to limit exposure to market swings in stocks, commodities, and other investment vehicles, and compete with individuals and organizations that may have greater access and/or larger order capacity. Therefore, investors are more greatly exposed to market prices and volatility. With high volatility comes the potential for devastating losses. We live in a world of financial marketplaces, where large volume positions, dollars directed toward bids or offers, and/or information can yield advantage. Although one needs to have a degree of knowledge and predictability, the outcome of weather markets cannot be forced or externally manipulated.

A current disadvantage within the weather risk management sector, also known as the weather derivatives industry, is lack of risk transferability. Investors do not have mechanisms for participating in financial indices or contracts that are non-customized, time perpetual, non-driven by energy needs/usage, and can be accessed by any investor.

Current weather derivatives lack a methodology that offers the investment and trading community at large, a series of indices that provide liquidity and risk transfer sources in the weather derivatives/weather risk management sector. Additionally, other than the HDD/CDD method, there is a lack of pricing methodologies for insurance products based on weather events or conditions.

Patent References:

U.S. Pat. Nos; 6,321,212; 4,883,526; 4,674,044; 6,012,042; 6,134,536; 5,270,922; 5,262,942 describe features related to one or more aspects of the invention.

U.S. Pat. No. 5,845,266: The principal techniques disclosed to enhance liquidity are to increase participation and traded volume in the system and to solicit trader preferences about combinations of price and quantity for a particular trade of a security. There are shortcomings to these techniques, however. First, these techniques implement order matching and limit order book algorithms, which can be and are effectively employed in traditional “brick and mortar” exchanges. Their electronic implementation, however, primarily serves to save on transportation and telecommunication charges. No fundamental change is contemplated to market structure for which an electronic network may be essential. Second, the disclosed techniques appear to enhance liquidity at the expense of placing large informational burdens on the traders (by soliciting preferences, for example, over an entire price-quantity demand curve) and by introducing uncertainty as to the exact price at which a trade has been transacted or is “filled.” Finally, these electronic order matching systems contemplate a traditional counterparty pairing, which means physical securities are frequently transferred, cleared, and settled after the counterparties are identified and matched. In other words, techniques disclosed in the context of electronic order-matching systems are technical elaborations to the basic problem of how to optimize the process of matching arrays of bids and offers.

Patents relating to derivatives, such as U.S. Pat. No. 4,903,201, disclose an electronic adaptation of current open-outcry or order matching exchanges for the trading of futures. U.S. Pat. No. 5,806,048 relates to the creation of open-end mutual fund derivative securities to provide enhanced liquidity and improved availability of information affecting pricing. This patent, however, does not contemplate an electronic derivatives exchange which requires the traditional hedging or replicating portfolio approach to synthesizing the financial derivatives. Similarly, U.S. Pat. No. 5,794,207 proposes an electronic means of matching buyers' bids and sellers' offers, without explaining the nature of the economic price equilibria achieved through such a market process.

Additionally, none of the above-reference patents include the use of event or program weather event deviation data to price and provide an insurance policy contract for hedging against the effects of such event deviations. Further, none or the above-referenced patents disclose a method of pricing such an insurance policy contract based on deviation from weather data, such as historical data and/or a weather index, and/or the purchase of weather derivatives based on deviation from such an index, wherein the settlement is based on weather measures that are independent of actual loss.

Therefore, it is readily apparent that there is a need for a weather insurance policy and a method of pricing such a policy based on deviations from a selected data value or index, wherein indemnification is based on deviation from historical weather data and/or a weather index, thereby providing individuals and companies with the ability to insure or hedge against variations and extremes in weather conditions and the effects caused thereby without the need for provable loss.

### BRIEF SUMMARY OF THE INVENTION

Briefly described, the present invention overcomes the above-mentioned disadvantages and meets the recognized need for such a method by providing a method for constructing an insurance policy/derivative pricing and risk-taking model based on deviation from historical data or projected values.

According to its major aspects and broadly stated, the present invention in its preferred embodiment is an insurance policy pricing model, wherein the model utilizes deviations from historical data and/or a weather index derived from global, domestic, regional and/or local weather data, perturbed by intraday trading.

The present invention is a method and system for determining the premium and/or contract structure based on weather measures at a given time for a policy insuring against specified weather conditions (meteorological data) occurring in a given location or locations. More specifically, the present invention is a method of generating a pricing model for determining a premium or other consideration for writing an insurance policy for a specified amount of risk coverage that hedges against the occurrence of a deviation or variability from a specified weather condition or conditions at a designated location or locations, during a selected time period.

The process for generating the pricing model requires a method for determining a deviation of current weather data from historical weather data. Unlike current insurance policy contract models that are actuarial-based, bench-marked, measure-specific, trigger-based or accumulated-measure-based, once a numerical indicator, or date-specific departure from normal weather measures, is generated, insurers can create a premium or other value of consideration for certain risk coverage. Thus, the weather pricing model encourages participation by risk acceptors, insurance companies, hedge firms, trading entities, banks, organizations, governments, individuals, brokers for commercial business hedging, and/or speculators. The pricing model is common to all parties, at any combination of worldwide locations, and can represent any combination of weather measures. The pricing model may be transparent to the user, that is, the underlying indicator may not be observed, or may be non-transparent, wherein all parties will know the methodology of creation of the numerical indicator.

The pricing method can generate an indicator utilizing a system configured to obtain weather measures, or data, from various sources and/or from an existing weather index. The weather measures are consolidated as needed with premium/loss history and a calculated numerical indicator is generated. Weather data or index values can be single or multiple date specific (i.e., isolated to a single day or multiple days) comparing any date to its historical high, low, average, or median or to its predicted value. For instance, the quantity may be utilized to create visual representations of actual weather values and/or departure from normal values, through graphs, charts and/or tables. The system may consolidate historical weather data and statistics, and current actual weather data, and transform such data into a quantity on which to base an exchange of consideration.

The method of the present invention creates a standardized numerical indicator, index or other quantified value by which insurance originators or risk acceptors can price counterparty weather exposure with the intention of having a liquid or otherwise standard market that is used by other risk acceptors. Pricing of the premium depends on the magnitude of the deviation from the predicted or historical measure value. This method provides a lower cost solution for the party in need of protecting risk, while providing the risk acceptor a process-unified market to mitigate and exchange such risk.

Embodiments of the invention are further directed towards a method and apparatus for generating and trading a perpetual index comprised of weather measures. Embodiments of the invention relate generally to systems and methods for receiving, analyzing, reformulating, transforming and distributing via reports such weather data, thus creating an ongoing and perpetual numerical value. The value, also referred to as an index, can describe deviations and/or departure from normal conditions. The index is designed for use and participation in and for financial and/or commercial enterprises and provides a free flowing, bilateral pricing mechanism that can be used to measure departure or deviation from normal and/or average weather conditions.

For instance, one embodiment of the invention provides a mechanism for identifying trends, based on daily to longer periods that consolidate, organize and formulate a departure from normal index in both precipitation and temperature. The index is developed using several cities and the cities may vary and change over time. For instance, weather measures are reported by a generally accepted source (e.g., from a particular city or location), collected, and aggregated to produce the daily, hourly or minute-by-minute update of the index value. Parameters are calculated with a running total of historical and similar data and aggregated with a baseline value. In this manner, the system can monitor multiple data elements either horizontally, i.e., same parameters for different locations or vertically, different elements within the same location making up a weather derivatives market. For instance, the system can be configured to consolidate regional, national and site specific weather monitoring data provided by a recognized producer of such data, example; WBAN stations and data as reported by the NCDC division, of the National Oceanic and Atmospheric Administration (NOAA), an agency of the United States. Input data can be provided by a specified historical time period hence producing a calculated numerical index value. The index can then treated as a tradable commodity in financial and other markets.

By carefully qualifying the data that is used, it is possible to ensure that only data relevant to that particular index is used in calculation of the index.

A status indicator can be presented to the user in a format, which conveniently conveys information regarding departure contributing to the condition of a security or financial market. Based on the indicator, the user can take appropriate action concerning investments in the security or financial markets.

Intended users of the index are typically institutional investors, such as financial institutions including banks, investment banks, primary insurers and reinsurers, and corporate treasurers. Users can also include any individual or entity with a need for risk allocation services. As used in this specification, the terms “user,” “trader” and “investor” are used interchangeably to mean any institution, individual or entity that desires to trade or invest in contingent claims or other financial products described in this specification.

A feature and advantage of the present invention is its ability to provide in meaningful form, an index that can be traded against, treating weather as a commodity.

A further feature and advantage of the present invention is that it can be tailored to regions and locales to provide business, individuals and investors with a summary index of weather based on historical and present data.

A feature and advantage of the present invention is that it provides for the investor, historical data and trends, and cannot be significantly manipulated by those creating a market in the trading of the index.

A further feature and advantage of the present invention is that it is it allows for historical data to be slightly perturbed by fluctuations intraday, thus creating a bid/ask differential that allows trading to advantage.

A further feature and advantage of the present invention is updated to provide a base index each day that provides a reference point for investors.

Another feature and advantage of the present invention is that it can be utilized to insure against negative or positive weather variability.

An additional feature and advantage of the present invention is that it can be utilized for financial protection of event weather risk, multi-day risk, seasonal risk, or risks of any time duration, with or without specific termination/expiry dates.

Yet another feature and advantage of the present invention is that it can be utilized for any location or a combination of locations.

Still yet another feature and advantage of the present invention is its ability to be utilized for any weather measure or combination of weather measures.

An additional feature and advantage of the present invention is its ability to be utilized for the secondary insurance market, also known as reinsurance, which can also benefit a pricing method by accepting portfolios of departure from normal weather policies, derivatives or financial contracts from brokers, originators or other market participants.

An additional feature and advantage of the present invention is its ability to handle multiple weather measures.

A further feature and advantage of the present invention is that it could be utilized to create financial contracts, including, but not limited to, swaps, time options, puts, calls, floors, indices and other instruments that could hedge or otherwise financially protect against weather risk.

Still a further feature and advantage of the present invention is that it could be utilized to protect against loss of revenue, higher expenses, or other direct or indirect financial loss by industries, such as, for exemplary purposes only, agriculture, transportation, leisure/resort, manufacturing, and retail, without the need for proof of loss in order to obtain indemnification.

Yet another feature and advantage of the present invention is that its method is applicable for any location, any weather measure, or time duration.

These and other features and advantages of the present invention will become more apparent to one skilled in the art from the following description and claims when read in light of the accompanying drawings.

### BRIEF DESCRIPTION OF THE DRAWINGS

Having thus described the invention in general terms, the present invention will be better understood by reading the Detailed Description of the Preferred and Alternate Embodiments with reference to the accompanying drawing figures, which are not necessarily drawn to scale, and in which like reference numerals denote similar structures and refer to like elements throughout, and in which:

FIG. 1A is a description of a general component environment configured to execute a preferred embodiment of the invention;

FIG. 1B is a flowchart of the process steps in determining a premium pricing model for an insurance policy contract according to a preferred embodiment of the present invention;

FIG. 2 is a flowchart illustrating steps involved in computing a weather derivative index;

FIG. 3 is a flowchart illustrating steps involved in computing a trading index using weather data in a preferred embodiment of the invention;

FIG. 4 is a description of a general hardware environment configured to execute a weather index according to a preferred embodiment of the invention;

FIGS. 5-7 illustrate examples a preferred embodiment of the present invention, in tabular and graphical form, as derived over various periods of time and based on different norms;

FIG. 8A illustrates the flow of information in the operation of a preferred embodiment of the present invention; and

FIG. 8B charts the flow of data information used in compiling the NORDIX index.

### DETAILED DESCRIPTION OF THE PREFERRED AND ALTERNATIVE EMBODIMENTS

In describing the preferred and alternate embodiments of the present invention, as illustrated in the Figures, specific terminology is employed for the sake of clarity. The invention, however, is not intended to be limited to the specific terminology so selected, and it is to be understood that each specific element includes all technical equivalents that operate in a similar manner to accomplish similar functions.

I. Overview of the Invention

The present invention pertains to insuring or protecting against deviations or departures from normal or average weather measures in exchange for a reasonable premium, consideration, or other cost structure.

Embodiments of the invention are directed toward a pricing method and apparatus for generating an indicator and a process to determine a price or value for consideration for an insurance policy contract premium, irrespective of whether such consideration is cash, credit, margin, or deferred payment. One embodiment of the present invention is a system for extracting historical weather data or projected values utilizing weather measures such as precipitation, wind speed, temperature and/or sunshine hours, providing such data to a computer database, and transforming the data via a computer and software program into a reported indicator utilized in the financial, weather derivative and/or insurance markets. The historical data is selected for a single location or for a plurality of locations. The reported indicator can be utilized as part of a pricing, mitigation or transfer determination. The pricing model is utilized for consolidating, processing, evaluating, transferring, monitoring, procuring, and delivering weather data as a commercially usable indicator for determining the premium on an insurance policy contract.

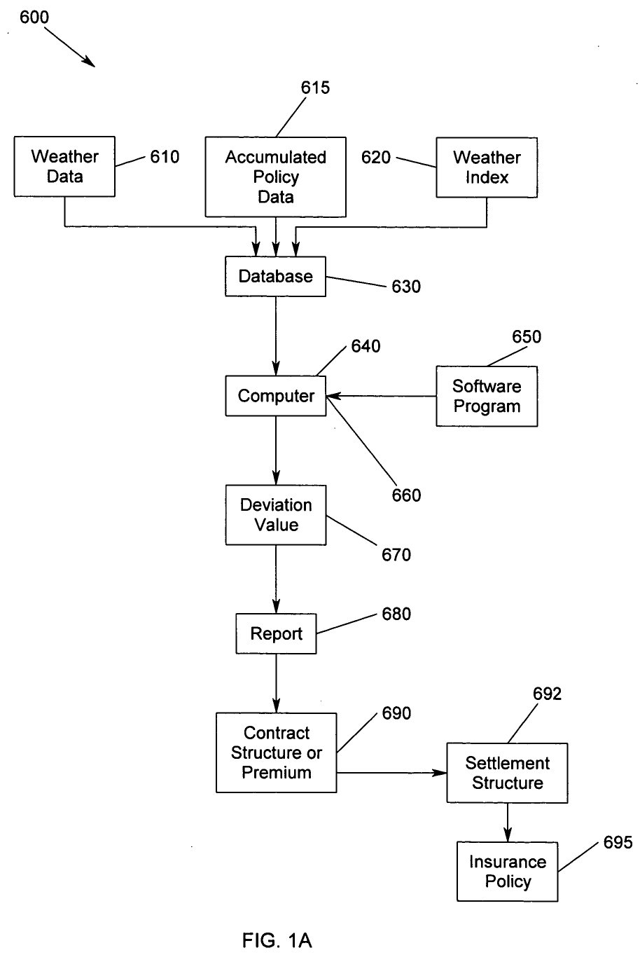

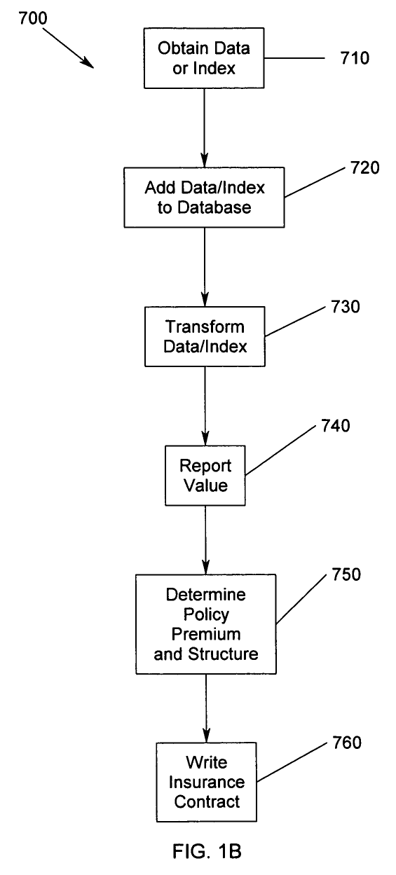

The preferred embodiment of the present invention, is a weather insurance pricing model, and method for premium and structure determination as depicted in FIGS. 1A and 1B, wherein the weather insurance pricing model utilizes an actual, or current, weather measure to obtain a deviation or departure from a predicted or historical measure. Weather measures utilized by the present invention include highs, lows, actuals, predicted values, averages and medians of temperature, wind speed, precipitation, humidity and sunshine hours.

The model comprises location data, measures (weather data), and specific expiration data for the purpose of providing a numeric indicator for a premium to an insurance policy contract.

The method of generating the weather insurance pricing model of weather, event insurance or derivatives pertains to determination of a premium, rated value or other consideration, for the purpose of granting coverage for a specific event or events, or for longer duration periods of weather risk coverage.

The invention uses a generally accepted weather source or index in a region or country applicable to the coverage desired in order to pre-qualify the data selected, and to prevent manipulation of the premium basis. The invention further provides for the premium to be selected based on the magnitude of the deviation, and/or for coverage limits to be based on the magnitude of the deviation from an historical measure or an index. The payout, or indemnification, is determined by the actual weather measure as opposed to a provable loss of use, revenue or other loss. The weather insurance method may provide for limitations of coverage and payout. The method provides a model for determining the likelihood of an occurrence based on historical data.

Actual values of weather measures are obtained from current or delayed reporting sources, wherein such weather measures include temperature, precipitation, humidity, wind speed and sunshine hours. A numerical indicator is subsequently utilized to reflect deviations from a norm, such as an historical value or index. The numerical indicator incorporates various weather conditions (e.g., a temperature median, high, or low, combined or exclusive, and averages, precipitation high, low, median and averages, combined or exclusive). The numerical indicator is utilized to represent the actual deviations and departures from historical weather data or from a weather index.

Once generated, the indicator is provided in a report and applied to financial, insurance or derivative markets worldwide for pricing and facilitation of generating weather contracts and/or derivatives. Thus, the indicator can be disseminated and utilized in the financial securities/derivatives and/or insurance markets, whether or not the indicator is available (transparent) to the policy or contract purchaser or counterparty.

The system can be adapted to process multiple types of weather data and the data may be qualified for suitability of inclusion prior to being incorporated into the indicator.

The indicator reflects a risk value of deviation of weather measures for a plurality of one or more locations and can be used in support of pricing determination of weather insurance and derivative contracts. The present invention consolidates components of weather measures for a plurality of, or single, geographic location resulting in one or more weather indicators based on a combination of individual or combined base factors, such as, for exemplary purposes only, single or multiple cities and/or regions, and the indicator may be based on single or multiple weather factors and/or measures. The historical weather data may include high, low, actual, median or average values covering a selected period or point in time for weather conditions including temperature, wind speed and precipitation.

Once a company, public municipality, or other entity has determined potential financial weather exposure, the effect of daily measures on business is quantified by determining the ideal weather measure for an event, multiple days, a season or longer. Subsequently, historical and current weather data values are qualified prior to inclusion in the database by obtaining the values from a readily-available generally-accepted source, such as, for exemplary purposes only, the United States National Weather Service/NOAA. Such sources are selected to avoid manipulation of the data. The method determines the amount of the weather measure to protect, price and otherwise cover, depending on whether the measure is above, below or at par with the expected historical data value. The payout or coverage of insurance is based on the deviation from the historical norm, wherein the actual weather is colder, wetter, hotter, windier, dryer, or sunnier than normal.

Weather policies, derivatives and other financial instruments are written and contracted for a specified time duration, with a specific expiration or settlement date, and reflect deviations from historical norms.

This method differs from a heating or cooling degree day in that the present method derives all values, including index and settlement values, from a deviation from the average, median, high, low, or other actual historic value or index, as opposed to from a fixed standard.

One form of historical data that is utilized in the preferred embodiment of the invention is a perpetual index comprised of weather data. Accordingly, embodiments of the present invention are further directed towards a method and apparatus for generating and trading a perpetual index comprised of weather data, as more fully set forth below. For example, aspects of the invention facilitate the process of aggregation, formulation, production, and distribution of indices, determined using weather data. One aspect of the invention is a system for extracting historical weather data using weather measures such as precipitation, wind speed, temperature and/or sunshine hours either jointly or severally, providing such data and transforming the result set into tradable indices in the financial markets, weather derivative and/or insurance markets. The transformed result set can be utilized as part of a method for establishing an automated weather index market for consolidating, processing, trading, monitoring, and delivering weather data as a tradable perpetual and commercially used index. Generally speaking, the invention provides one or more of the following:

Index Represents Deviations from Normal: A method and system for monitoring weather data; actuals converted to a numerical index value plus par. The numerical index incorporates various weather conditions (e.g., a temperature mean and averages and precipitation mean and averages) and can be used to measure the actual deviations and departures from normal in the weather.

A Tradable Commodity: Once generated, the index can be formed into a report and applied to the financial markets worldwide for the trading and facilitation of weather contracts and/or derivatives. Thus, the index can be disseminated and used in the financial securities/derivatives markets.

Real Time: The index is generated using a system configured to implement a process for collecting information on weather activity in real time. Upon collection the weather information is consolidated for use as a quantifiable index of values.

Handles Multiple Weather Measures: The system can be adapted to process multiple types of weather data and that data may be qualified for suitability of inclusion prior to being incorporated into the index structure.

Accounts for Multiple Locations: The index provides a real time indicator of weather measures for a plurality of one or more locations and can be used in support of automated trading in futures and options contracts. The present invention consolidating components of weather measures and combines a plurality of geographic locations to result in one or more than one weather indices based on a combination of individual or combined base factors. The index may be based on single or multiple cities and/or regions, and may be based on single or multiple weather factors and/or measures.

The process for generating the index is set forth in further detail below. Once the weather index is generated, participants can be given discretionary access to the index for purposes of speculation incentive for profit, business hedge, market facilitation, and/or any other useful purpose. Unlike current weather indices, the index generated in accordance with an embodiment of the invention is time perpetual and not based exclusively upon energy and/or energy-related events, consumption, demand and/or pricing models. Thus, the weather index encourages participation by business, hedge firms, trading entities, banks, organizations, governments, individuals, brokers for commercial business and/or speculation.

The index can be generated using a system configured to obtain weather measures from various sources, consolidate such weather measures, and generate a calculated numerical value consolidated with a baseline value to derive a tradable, visually referenceable index. For instance, the index may be used to create visual representations of actual and departure from normal values through graphs, charts and tables. The system may consolidate historical weather statistics and actual weather data and recalculate such data into a financial tradable index. The index is free flowing, time perpetual numeric value representative of a departure from normal. The index is derived so as to incorporate both positive and negative numerical data. Calculation is independent of potentially modified and/or manipulated components.

In accordance with an embodiment of the invention, the index' numerical value is derived from weather measures and enables parties to participate by means of bid and offer for transaction value at a specified numerical value with one or more counterparts. The process involves multi-party participation. The traded numerical value of the index fluctuates based upon best bids and offers from multiple parties. The index can inherently have bid and ask price offerings corresponding to one or more of said regional, national, international, and/or worldwide indices. Embodiments of the invention enable the user to enjoy increased liquidity, improved information aggregation, increased price transparency, reduced clearing costs, reduced event risk, increased liquidity incentives, reduced influence by market makers, and reduced hedging costs. In addition to the trading of weather derivatives, embodiments of the invention also facilitate the trading of other

a. financial-related contingent claims,

b. non-financial-related contingent claims such as energy, physical commodity, and traditional insurance and reinsurance contracts, and

c. contingent claims relating to events which have generally not been readily insurable such as corporate earnings announcements.

Some examples of weather measures used in accordance with an embodiment of the invention include data for weather related values such rainfall, snowfall, sunlight hours, temperature, humidity, barometric pressure, wind speed, and/or any other weather related information.

Turning now to FIGS. 1A and 1B, pricing model components 600 are utilized by process flow diagram 700 to transform data 610, 615 and 620 into financial contract structure/premium/consideration 690 and settlement structure 692, wherein insurance policy 695 is offered with risk based upon the magnitude of the deviation from historical values or an index. The policy terms could further include a deductible limit based on historical deviations from normal historical values, wherein the deductible limit must be exceeded for payout to occur, or alternately the amount of the historical deviation from a normal historical value could be factored into the premium.

Historical weather data 610 is extracted and/or an index 620 is obtained in step 710. Data 610 or index 620 is then provided to the computer database 630 in step 720, wherein data 610 or index 620 is combined with accumulated policy data 615 and collected qualified current weather data 610 from qualified weather reporting sources, operated upon by computer 640 via software program 650 to determine deviation as numeric indicator 670 from historical data 610 or index 620, thereby transforming in step 730 data 610, 615 and 620 into numeric indicator 670, which is then provided in report 680 via step 740. Report 680 is subsequently utilized by an insurance company or financial contract maker to price the policy or contract 750 and write the contract 760.

Report 680 may also be generated as a contract of insurance as set forth as Example A following:

### Example A

Copyright 2004, Daniel J. Parker, All rights reserved worldwide

Confirmation

OTC NORDIX™ Weather Index Insurance Transaction Swap/Structured Option/Weather Policy

[Party A/Originator]

[Party B/Customer]

[Name and Address]

[Direct Contact]

[Telephone]

[Fax]

[Date]

Attention:

The purpose of this communication (“Confirmation”) is to confirm the terms and conditions of the NORDIX™ Weather Index Transaction entered into between [NAME OF PARTY A] (“Party A”) and [NAME OF PARTY B] (“Party B”) on the Transaction Date specified below (the “Transaction”).

The terms of the Transaction to which this Confirmation relates are as follows:

Transaction Terms.

| | |
|---|---|
| Transaction Type: | OTC NORDIX ™ Financial Weather Transaction |
| Notional Amount: | [USD/EURO/CAD/GBP] |
| Transaction Date: | [TRANSACTION DATE] |
| Effective Date: | [EFFECTIVE DATE] |
| Termination Date: | [TERMINATION DATE] |
| NORDIX ™ Buyer: | [Party A/Party B] |
| NORDIX ™ Seller: | [Party A/Party B] |
| Current Fair Value | [Station/Average Multiple Stations] |
| Marked to Index | [Yes/No] |
| Weather Condition(s): | [Precipitation, Temperature, Multiple] |
| Weather Measurement | [Inch, Centimeter, Degree F, Degree C] |
| Rounding of | NORDIX ™ Precipitation Index rounded to .01 inch or |
| NORDIX ™ Index: | converted precipitation. |
| | NORDIX ™ Temperature Index rounded to full degree or |
| | converted temperature. |
| Calculation Period: | [The period from and including the Effective Date to and |
| | including the Termination Date]. |
| Party A Position | Less/Lower departure from normal/More/Greater |
| | departure from normal |
| Party B Position | Less/Lower departure from normal/More/Greater |
| | departure from normal |
| Settlement Data | [NCDC/NWS preliminary data]. |
| Temperature Reference Level | [Deviation from Mean, High, Low] |
| Precipitation Reference Level | Deviation from Actual |
| Agreed Index Level | [Daily Fair Value] |
| Index Start/Finish | [Date/Level] [Date Level] |
| Payout | [Insert amount per inch, degree from Agreed Index Level] |
| Cap/Limit | [Aggregate, Daily, Per Degree, Per Inch] |
| Other Terms | [List Other Terms] |
| Fallback Weather Index | [City], [Airport Name], [WBAN], [WMO] |
| Station: | |
| Second Fallback | [City], [Airport Name], [WBAN], [WMO] |
| Weather Index Station: | |
| Payments to [Party A]: | |
| Pay: | [Specify] |
| For the Account of: | [Specify] |
| Account Number/ | |
| [CHIPS UID]: | [Specify] |
| [Fed. ABA No.]: | [Specify] |
| Payments to [Party B]: | |
| Pay | [Specify] |
| For the Account of: | [Specify] |
| Account Number/ | |
| [CHIPS UID]: | [Specify] |
| [Fed. ABA No].: | [Specify] |

### [Broker/Arranger]

### [Other Provisions]

Please confirm that the foregoing correctly sets forth the terms of the Transaction entered into between us by executing a copy of this Confirmation and returning it to us or by sending to us a letter substantially similar to this letter, which letter sets forth the material terms of the Transaction to which this Confirmation relates and indicates your agreement to those terms.

| | |
|---|---|
| | Yours sincerely, |
| | [PARTY A] |
| | By: |
| | Name: |
| | Title: |
| Confirmed as of the | |
| date below: | |
| [PARTY B] | |
| By: | |
| Name: | |
| Title: | |
| Date: | |

Copyright 2004, Daniel J. Parker, All rights reserved worldwide

As set forth in Example A above, report 680 in the form of a contract of insurance includes sections indicating the parties to the contract, the terms of the contract, the agreed weather measures, the premium and settlement amounts and/or methods, other information and signature blocks.

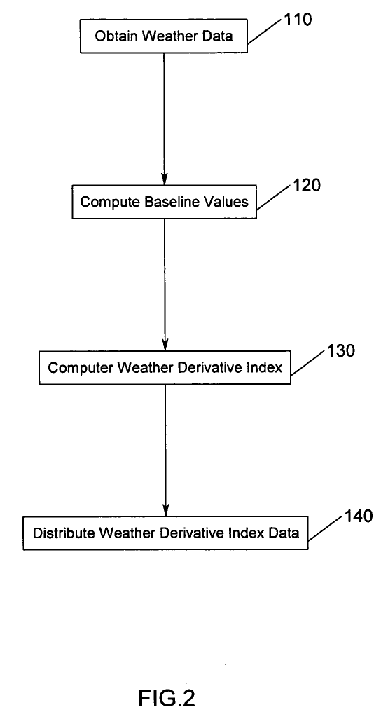

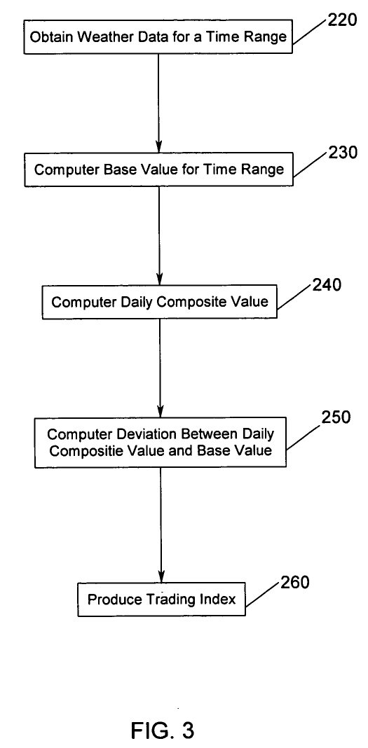

FIGS. 2 and 3 illustrate a general overview of the process for deriving an index in accordance with an embodiment of the invention. More specifically, FIG. 2 is a flowchart illustrating steps involved in computing a weather derivative index.

At steps 110, a system implementing the invention obtains weather data from one or more sources.

At step 120, the system computes baseline values obtained from historical data using one or more algorithms to combine the data.

At step 130, the system computes an index derived from actual data in combination with historical data.

At step 140, the system distributes the computation results in report form to one or more receivers using one or more communications means for distributing data. Receivers refer to persons that may request access to the data. Receivers also refer to machine such as computers that may host data communication services. Communication means refer to any type of communication means comprising all person to person communication (e.g., oral communication through a customer service call center), and networking means such the Internet.

FIG. 3 is a flowchart illustrating steps involved in computing a trading index using weather data in an embodiment of the invention.

At step 220, a system embodying the invention obtains one or more types of weather data from one or more locations.

At step 230, the system uses the weather data for a time range to compute a baseline.

At step 240, the system obtains current or anticipated weather data, and computes a new value for the given time mark. For example, the computation may involve an average temperature for a given day. The computation may involve selecting one or more geographical areas using one or more specific selection criteria. For example, one embodiment of the invention computes the average temperature of four (4) cities in a wide geographical area. The system then computes the average temperature of the four cities.

At step 250, the system computes a composite index based on one or more averages. For example, the system may combine an average based on temperature and an average based on atmospheric pressure.

At step 260, the system couples a combination of one or more weather data averages (computed at step 250) with the historical weather data to produce a compound index. For example, the system may compute a daily temperature average from four different cities, then compute a deviation of that average from an expected average value based on the historical weather data. The average deviation may then be normalized and/or corrected based on or more criteria (e.g., correcting temperature values based an error related to global warming data). The deviation may be a positive or a negative value. A compound index may then updated with the newly generated data. For example, a compound index derived from weather data may be updated with a daily deviation. A deviation in temperature, expressed in degrees Fahrenheit, may be added to the compound index, which may have an initial value of, such as for exemplary purposes only, one thousand (1000).

Now that a general overview has been given, the process for deriving the tradable index will be described in further detail. The process generally described above typically initiates by obtaining a set of weather measures.

II. Obtaining Weather Measures

The weather measure(s) to be utilized are obtained in one embodiment of the invention from one or more monitoring locations. Each weather measure represents any measurable weather condition and/or its action. Examples include, but are not limited to wind speed, temperature, snowfall, rainfall, sunlight, and/or hail fall. Measurements include direction, time of day, duration, speed, amount in common measurement or conversion thereof. Each weather measure can be defined so that the measure corresponds to a particular location, range of locations, or multiple locations (e.g., a city, cities, county, counties, state, or states, etc.). Numerical weather values for pre-selected cities, regions and countries are created based on weather measures and distributed accordingly.

A. Weather Measures

Normal weather measures are historical data representative of a particular weather measure or set of weather measures during a given period of time (e.g., a day, week, month) at a particular location. Normal weather measures are obtained in one embodiment of the invention from a recognized authority such as the NCDC. Each location can be assigned a station name that identifies the location as a standard derived measurement location. However, the invention contemplates the use of any source for any measure that defines the historical weather patterns in an area (e.g., any definable location or locations) within a reasonable certainty. For instance other sources or statistical projections can be utilized to obtain the normal weather measures. In one embodiment of the invention, the daily normal value of a weather variable is computed as a 30-year moving average, marked day to day. Each day can be updated to include data from the prior day's 30-year up-to-date history. The normal weather measures may contain values such as the daily mean temperature and daily sum. The daily mean temperature used in accordance with an embodiment of the invention is the average temperature between highest recorded and lowest recorded within a calendar day, in degrees Fahrenheit, degrees Celsius, or conversion thereof. The daily sum is a value representing the accumulation of precipitation snowfall, waterfall, and hail in a calendar day, per inches or some conversion thereof. In one specific embodiment of the invention, a normal weather measure (e.g., a climate normal) is defined as the arithmetic mean of a climatological element computed over three consecutive decades (WMO, 1989). Ideally, the data record for such a 30-year period should be free of any inconsistencies in observational practices (e.g., changes in station location, instrumentation, time of observation, etc.) and be serially complete (i.e., no missing values). In the application of these methods, adjustments are made so that earlier periods in the data record more closely conform to the most recent period. Likewise, techniques have been developed to estimate values for missing observations. After such adjustments are made, the climate record is said to be “homogeneous” and serially complete. The climate normal can then be calculated simply as the average of the 30 values for each month observed over a normal period like, such as for exemplary purposes only, 1961 to 1990. By using appropriately adjusted data records where necessary, the 30-year mean and/or average value can more closely reflect the actual average climatic conditions at all stations. Although, normal weather variables are defined as average daily data for a 30-year—to date moving period, the reader should note that other methodologies for calculating a normal weather measure are contemplated as falling within the scope of the invention.

III. Deriving the Index

Once obtained, the historical normal weather measures are combined with actual weather measures (the value of the weather measure on the day the measurement is taken) to derive an overall composite index. The composite indices may include several locations. For instance, the composite indices can include several United States locations and a United States National index containing some or all of the component regions and locations. The indices are derived using a combination of weather measures such as daily precipitation, wind speed, sunlight hour and temperature means, actual highs and lows and historical data and/or averages thereof. Both preliminary and final data records can be used. Updates to the database of weather measures can be performed upon scheduled updates to maintain the consistency of the database. The data processing system provides for the compilation of large quantities of disparate weather measures into discrete data files of varying reliability.

In one embodiment of the invention, the index is calculated using a mathematical formulation to complete an operative data set. The resulting countable index may fluctuate higher and/or lower depending upon the weather measure calculations. In one embodiment of the invention, the raw actual data is calculated and subsequently expressed in terms of numerical price relative to a par value. The result changes absolute value daily with the addition of new data.

In implementations using actual weather data, the index value can support an automated trading function for futures and/or options contracts based on the numerical changes and content value of the index. The index provides a numerical, graphical and tabular view into the departure from normal over a threshold factor of time (e.g., the past 30 years and counting). Thus, the index provides a mechanism for measuring the departure from “normal” weather variables on a daily or some other periodic basis.

The data is thereafter qualified and then processed to calculate on an iterative basis the term structure of weather data in real time for a defined cross-section of worldwide locations. The forgoing portfolio is characterized in terms of an index value having a current market price. Market price may differ from its actual or fair value. As market conditions change, the processor selectively updates some or all of the locations. In the event of location modification, the calculation and data source and formulation criteria remain unchanged.

Fair value is the actual numerical value plus par. Fair value, calculated once per calendar day, represents the actual occurred data, which together with par value can sum to the daily fair value. Thus embodiments of the invention provide a mechanism for transforming measured actual values into an index using a function dependent on at least one baseline and critical values of the parameters. Actual trading prices, bids, offers, and executed contract or index prices and/or values may fluctuate between the time period of fair value calculation/release to the calculation/release of the following calendar day. Intraday trades cannot necessarily trade at fair value, as short-term supply and demand can cause price to fluctuate around fair value. Price discrepancies above or below fair value should cause arbitrageurs to return the market closer to its fair value. The following formula is used in one embodiment of the invention to calculate fair value for this weather index:

I = actual daily departure from daily normal [1.00] +
[1000.00 Par] = Daily Fair Value
*1.00 an example of a departure from normal
*departure from normal numerical values can be positive or negative

addition of actual weather data, either real time or historical. Thus, the index differs in measurement capability and/or use, from the measurement of energy use, consumption, demand and/or general measurement of electric, natural gas, solar, wind or water energy.

IV. Index Uses

The index provides a mechanism for consolidating and calculating weather information. In one embodiment of the invention, the index becomes a tradable commodity used for speculation, prediction, hedge, financial protection strategy, normalization of revenue and/or a combination thereof. The index can sponsor trading and/or participation within the commercial and/or financial markets. The resulting index value may be associated with a symbol or some other character identifier used to refer to the index. In one or more embodiments of the invention, the index has a closing price that equals the last sale price for the index of the previous trading day. The index can also be associated with a tick that represents the traded and recorded departure from normal value actual or perceived. The component percentage represents the weighting of each component issue in the index (market value of the issue divided by the total market value of the index). The index can be integrated into a system for electronically exchanging weather measures and events, which includes one or more of the following features:

reduced transaction costs, including settlement and clearing costs associated with derivatives transactions and insurable claims;

reduced dependence on complicated valuation models for trading and risk management of weather derivatives;

increased availability to traders of accurate and up-to-date information in the trading of weather markets, including information regarding the aggregate amounts invested by and through all counterparts.

In the trading of business risk, speculation, and facilitation in traditional financial markets, it is frequently useful to distinguish between fundamental value as determined by market expectations, information, risk aversion and financial holdings of traders, and the deviations from such value due to liquidity variations. Embodiments of the invention produce a fair value that is unchangeable, uncontrollable, and independent of manipulation by any market participant. Fair value is calculated by actual weather conditions as declared and released by a recognized authority.

True and actual trading levels can deviate from actual fair value, but increased risk of realignment is present, after the calendar day is complete and mark to market is set. Price and quantity relationships can greatly vary, therefore, due to liquidity variations. At some point a counterpart can decline to accept any additional positions and therefore show resistance in the offering price. The actual weather measure can always determine fair value without exception. Although open participation can allow liquidity, the amount at which the index can be bought or sold may be limited and reflected in the price accordingly.

Offers and bids can be based upon future actual events at face value and the additional dimension can include how weather events may affect business and what hedge strategy is deployed, and what hedge is applicable either by multiple indices and/or a single index strategy. The effect of a large infusion of position in either bid or offer may, of course, move intraday trading values, but fair value can remain based on actual weather measures. The difference between traded value and fair value may be perpetual or may be intermittent.

An embodiment of the present invention comprises a system for aggregating reported weather data, by generally accepted sources containing accurate and true data with one or more measured variables, such as for exemplary purposes only, and not limited thereby, rainfall, snowfall sunlight hours, temperature values, and hail. Measurement is defaulted to inches and degrees, but can be converted to other measurement formats. A common composite index provides liquidity to the financial markets while maintaining measurement accuracy of all contributing variables. The disclosed system uses weather variables to determine index numerical values.

The intraday index value, although being supported by actual historical data, can fluctuate in value based upon perceived risk, participation and speculation of future weather conditions. Each closing/calendar day data can be calculated and a numerical value known as ‘fair value’ representative of actual data may be determined, separate from fluctuating intraday bids and/or offers.

Participants have an opportunity to encompass their own view of value and perceived risk. This perception may force intraday valuations higher and/or lower. The outcome, or end of day fair value, however, cannot be controlled or manipulated by any individual, government, industry, or firm. The actual data can calculate and set the index to fair value once each calendar day. Participation in the indices shall encompass individual investors, brokers, institutions, industrial firms, governments and/or agencies thereof, private and public companies, and/or institutions. The participants can place buy and sell orders through brokers, clearing organizations and/or electronic exchanges. The system can encourage market participation by such investors, whereby their participation provides liquidity to the weather derivatives and related financial markets.

V. System Configuration

In one embodiment of the invention a computer system or set of interconnected computer systems are configured to generate the index. For example, the invention contemplates the use of a computer system having a medium for obtaining and storing historical data (e.g., weather measures). The historical data may, for example, be stored in a computer database organized according to a set of one or more attributes. Once the historical data and actual data are obtained, the computer utilizes an index generation module to derive the index in accordance with the methodologies contemplated herein. For instance, the index generation module or any other software program or component can be configured to implement a obtain weather measures in any unit (e.g., inches, mph, sunlight hours and temperature degrees or conversion thereof) and generate an indicator for use in reporting changes in the weather. This is accomplished in one or more embodiments of the invention using a collection step for recording a plurality of index values associated with the market on a computer-readable medium; a transformation step for transforming each value of the index values using a function dependent on at least one baseline and critical values of the index value; a mapping step for mapping the function to a sequence of reference values and generating a plurality of deviation indicators, each security index value having one of the deviation indicators associated therewith; and an analysis step for analyzing and reformatting raw data to produce departure and deviation indicators and generating a numerical index value. The index value will typically include data collections from a generally accepted provider for a proper set of weather associated events and variable with the daily, hourly, and simultaneous data contributing to the result set and index value. The data collections can be received in real time or as it becomes available corresponding to weather activity at one or more worldwide locations. The specific locations contributing to the index may change over time.

The index generation module provides a mechanism for iteratively establishing an index corresponding to a plurality of weather risk related variables and participants expressed in terms of one or more of the following: location, daily normal and aggregates thereof, standard deviation, and duration; closing value, daily normal and aggregations thereof; daily mean and aggregations thereof; average; component value; and composite value. Thus, the index generation module provides a mechanism for quantifying the difference in value between normal and departure from normal in both temperature and precipitation. The system may also have an input means by which a party can receive index data relating to at least one weather related phenomenon, each said phenomenon having a range of future outcomes and a perpetual and ongoing time of maturity.

The above-described systems provide a basic means for the monitoring of multiple parameters, either for the diagnosis of and solution to a problem, or for the evaluation of the condition of an entity that, through analysis, reasonably would give one a well-founded basis to anticipate possible future changes. It is reasonable that from weather parameters one may draw similar conclusions into the predictability or lack thereof of future events. Many systems exist that are designed to measure many weather variables such as, rainfall at a location, and/or wind speed and direction, but none provide the ability to monitor a number of parameters which can be transformed into a single indicator for use in projecting future deviation and/or analyzed, based upon departure from recognized normal value with time perpetual applicability.

The computer system is configured in one embodiment of the invention to combine a plurality of historical and real time weather event data for at least one weather event in at least one physical location. The weather event data can be arranged in a multiplicity of records according to a first sequential format and associated with a location or multiple locations. In accordance with one or more embodiments of the invention, the system is further configured to generate a table of records for locations and/or combinations thereof, in which weather measures and effects are consolidated. The table may contain a multiplicity of rows and columns where each row of the table comprises a multiplicity of records substantially arranged in accordance with the first sequential format. The tables can be combined, and calculated, with or without a basis, to achieve the numerical index value. Inserting the numerical index value into the corresponding records of a second row of the table, one obtains the respective corresponding weather measure data values within a basis or starting point.

The following tables Illustrate an example index derived in accordance with an embodiment of the invention.

TABLE A
Richmond, VA

| Date | Max. Temp. | Min. Temp. | Mean Temp |
|---|---|---|---|
| Oct. 20, 2002 | 64.0 | 56.0 | 60.0 |
| Oct. 21, 2002 | 56.0 | 49.0 | 52.5 |
| Oct. 22, 2002 | 62.0 | 45.0 | 53.5 |
| Oct. 23, 2002 | 70.0 | 43.0 | 56.5 |
| Oct. 24, 2002 | 60.0 | 50.0 | 55.0 |
| Oct. 25, 2002 | 59.0 | 46.0 | 52.5 |
| Oct. 26, 2002 | 72.0 | 51.0 | 61.5 |
| Oct. 27, 2002 | 65.0 | 54.0 | 59.5 |
| Oct. 28, 2002 | 56.0 | 47.0 | 51.5 |

TABLE B

| | Average | Normal | |
|---|---|---|---|
| | for | for | NORDIX |
| Record | regional | regional | index for |
| Date | cities | cities | region |
| 10.20 | 48.9 | 52.0 | 3333.3 |
| 10.21 | 45.3 | 52.4 | 3326.2 |
| 10.22 | 44.3 | 52.1 | 3318.4 |
| 10.23 | 43.3 | 51.9 | 3309.7 |
| 10.24 | 40.9 | 51.6 | 3299.0 |
| 10.25 | 43.0 | 50.9 | 3291.1 |
| 10.26 | 50.8 | 50.5 | 3291.3 |
| 10.27 | 50.4 | 51.3 | 3290.5 |
| 10.28 | 44.6 | 50.6 | 3284.4 |

Data for Buffalo, N.Y.; New York, N.Y.; Boston, Mass.; Baltimore, Md.; Albany, N.Y.; Burlington, Vt.; Williamsport, Va.; and Richmond, Va.

In this example, referring to Table A, an index is chosen to encompass selected data from selected cities. In particular, temperature high and temperature low for each of eight cities have been chosen. From these data, a mean temperature for each city is determined for each date of a date range.

Next, referring to Table B, the means for that date are averaged. Then the averages for that date for the past twenty-five years are further averaged to determine a normal value. Finally, an index is computed by taking the previous date's index and adding to it the positive or negative difference between that date's average and normal values, where in the difference is obtained by subtracting the normal from the average. In this fashion, a continuous running index is obtained.

Definitions in Accordance with an Embodiment of the Invention:

Recording means to record a plurality of weather related data that support the result set of the index.

Transformation means transform each value of the plurality of weather data index values associated with markets, using a function dependent on at least one baseline and critical values, used to culminate the index value.

Mapping means to map the function to a sequence of reference values and generating a plurality of deviation indicators, each index value having one of the deviation indicators associated therewith.

Analysis means to analyze raw data and generate an average deviation and/or departure value and indicator.

Precipitation value means to provide an index value corresponding to a portfolio of pre-select cities, states, regions, and/or countries or consolidation thereof. Data is expressed in terms of precipitation inches or translation/conversion thereof, and duration, wherein said index value is used to support a market in futures and options contracts.

Temperature value means to provide an index value corresponding to a portfolio of pre-select cities, states, regions, and/or countries or consolidation thereof. Data Is expressed in terms of temperature degrees or translation/conversion thereof, and duration, wherein said index value is used to support a market in futures and options contracts.

Wind speed value means to provide an index value corresponding to a portfolio of pre-select cities, states, regions, and/or countries or consolidation thereof. Wind speed may be measured via land surface or over water. Data is expressed in terms of miles per hour (mph) translation/conversion thereof, and duration, wherein said index value is used to support a market in futures and options contracts.

Sunlight hours means to provide an index value corresponding to a portfolio of pre-select cities, states, regions, and/or countries or consolidation thereof with regard to sunlight hours.

Reformatting means to reformat actual weather data to create an index corresponding to generic issues and calculate a composition of current and past data.

Communicating means to communicate the results of said calculated index values and distribute such data in said real time to market participants for commercial, private and/or use in the financial markets, including but not limited to securities and commodities markets, distributing electronic data corresponding to said differential to one or more future and/or options trading exchanges and the public and private sectors worldwide.

Component value means the time incremental numerical value of one or more weather events or variables. The component values can be combined to conclude a composite. The component value may also be recorded, analyzed, and reproduced independently as component values of the index. Contributing component locations may change over time.

Composite value means the consolidation and/or aggregation of more than one component value.

Tradable index means a composite and/or consolidation of data mathematically calculated to produce a result set that is numerical and time perpetual. The index values are viewed as charts, tables and/or graphs, or other digitally compiled format. The up-to-the-minute values are transferred to one, or more than one, participants through trading on a bid/ask basis and confirmation of trade, and/or execution thereof.

Embodiment of Computer Execution Environment (Hardware):

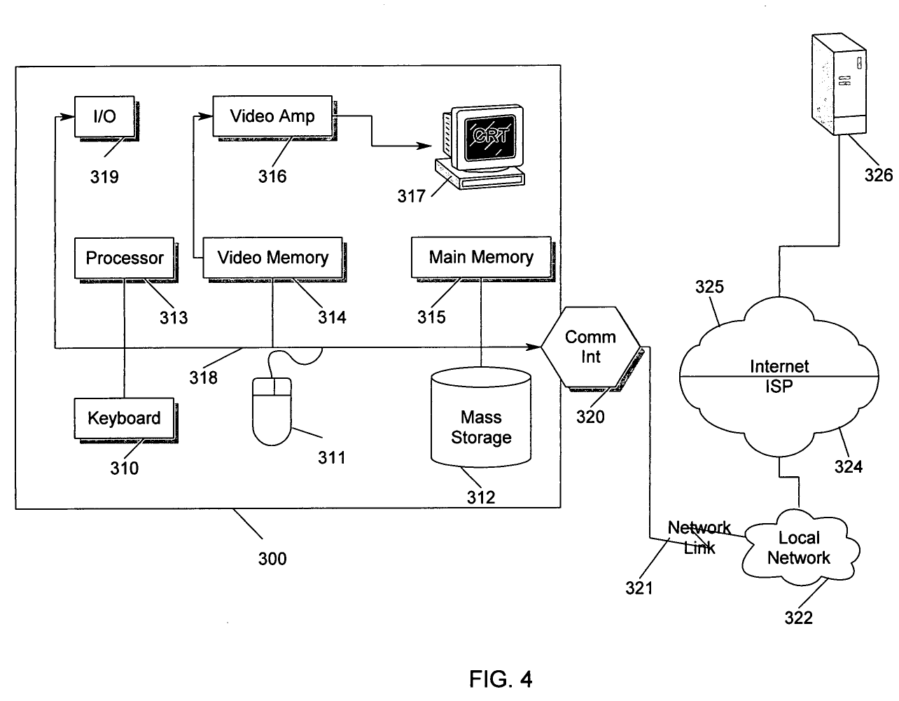

Computer software implemented as computer readable program code can be configured to generate the weather index (e.g., the index generation module) and executed on a general purpose computer such as computer 300 illustrated in FIG. 4, or in the form of bytecode class files executable within a JAVA™ runtime environment running on such a computer, or in the form of bytecodes running on a processor (or devices enabled to process bytecodes) existing in a distributed environment (e.g., one or more processors on a network). A keyboard 310 and mouse 311 are coupled to a system bus 318. The keyboard and mouse are for introducing user input to the computer system and communicating that user input to processor 313. Other suitable input devices may be used in addition to, or in place of, the mouse 311 and keyboard 310. I/O (input/output) unit 319 coupled to system bus 318 represents such I/O elements as a printer, A/V (audio/video) I/O, etc.

Computer 300 includes a video memory 314, main memory 315 and mass storage 312, all coupled to system bus 318 along with keyboard 310, mouse 311 and processor 313. The mass storage 312 may include both fixed and removable media, such as magnetic, optical or magnetic optical storage systems or any other available mass storage technology. Bus 318 may contain, for example, thirty-two address lines for addressing video memory 314 or main memory 315. The system bus 318 also includes, for example, a 64-bit data bus for transferring data between and among the components, such as processor 313, main memory 315, video memory 314 and mass storage 312. Alternatively, multiplex data/address lines may be used instead of separate data and address lines.

In one or more embodiments of the invention, the processor 313 is a microprocessor manufactured by Sun Microsystems, Inc., such as the SPARC™ microprocessor, or a microprocessor manufactured by MOTOROLA™, such as the 680×0 processor, or a microprocessor manufactured by INTEL™, such as the 80×86, or PENTIUM™ processor. However, any other suitable microprocessor or microcomputer may be utilized. Main memory 315 is comprised of random access memory, static or dynamic (SRAM or DRAM). Video memory 314 is a dual-ported video random access memory. The video memory 314 is coupled to video amplifier 316. The video amplifier 316 is used to drive the monitor 317, typically for exemplary purposes only, a cathode ray tube (CRT) raster monitor. Video amplifier 316 is well known in the art and may be implemented by any suitable apparatus. This circuitry converts pixel data stored in video memory 314 to a raster signal suitable for use by monitor 317. Monitor 317 is a type of monitor suitable for displaying graphic images.

Computer 300 may also include a communication interface 320 coupled to bus 318. Communication interface 320 provides a two-way data communication coupling via a network link 321 to a local network 322. For example, if communication interface 320 is an integrated services digital network (ISDN) card or a modem, communication interface 320 provides a data communication connection to the corresponding type of telephone line, which comprises part of network link 321. If communication interface 320 is a local area network (LAN) card, communication interface 320 provides a data communication connection via network link 321 to a compatible LAN. Wireless links are also possible. In any such implementation, communication interface 320 sends and receives electrical, electromagnetic or optical signals, which carry digital data streams representing various types of information.

Network link 321 typically provides data communication through one or more networks to other data devices. For example, network link 321 may provide a connection through local network 322 to local computational service provider computer 343 or to data equipment operated by an Internet Service Provider (ISP) 324. ISP 324 in turn provides data communication services through the world wide packet data communication network now commonly referred to as the “Internet” 325. Local network 322 and Internet 345 both use electrical, electromagnetic or optical signals, which carry digital data streams. The signals through the various networks and the signals on network link 321 and through communication interface 320, which carry the digital data to and from computer 300, are exemplary forms of carrier waves transporting the information.

Computer 300 can send messages and receive data, including program code, through the network(s), network link 321, and communication interface 320. In the Internet example, remote computational service provider computer 326 might transmit a requested code for an application program through Internet 325, ISP 324, local network 322 and communication interface 320.

The received code may be executed by processor 313 as it is received, and/or stored in mass storage 314, or other non-volatile storage for later execution. In this manner, computer 300 may obtain application code in the form of a carrier wave.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, computational service providers on a network, and carrier waves.

The computer systems described above are for purposes of example only. An embodiment of the invention may be implemented in any type of computer system or programming or processing environment. When a general-purpose computer system such as the one described executes the process and process flows described herein, it is configured to adaptably distribute index data to one or more recipient devices. Thus, a method and apparatus for generating a weather index has been described.

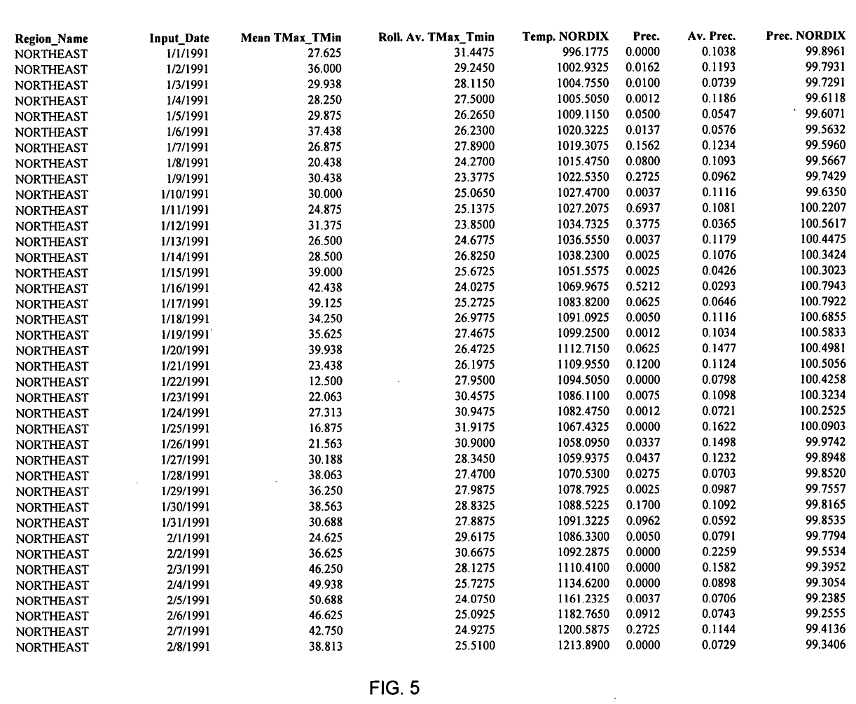

FIG. 5 is a table showing, for exemplary purposes only, the Temperature NORDIX index and Precipitation NORDIX index for the Northeast region.

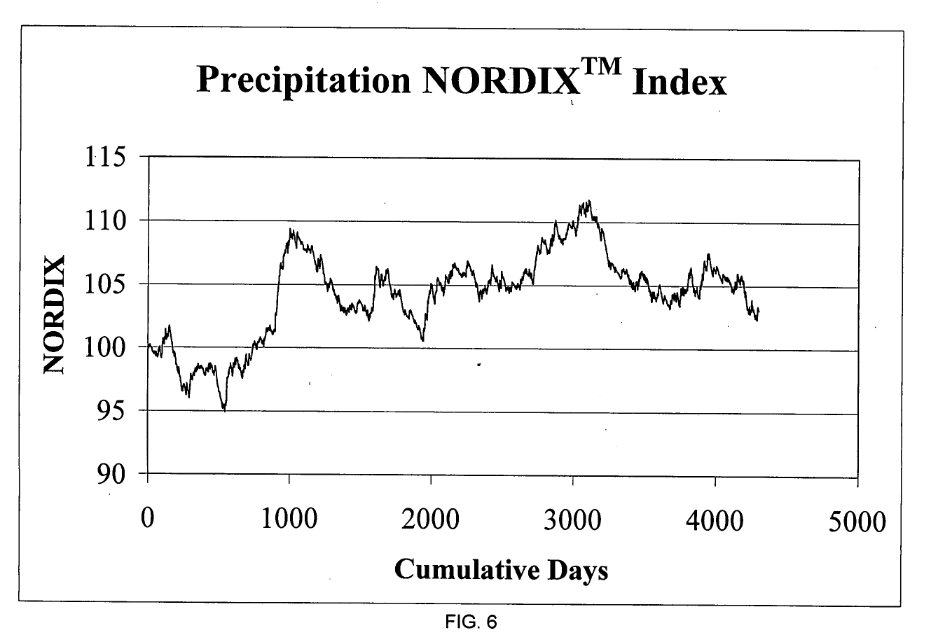

FIG. 6 is a graph, for exemplary purposes only, of a Temperature NORDIX index shown over a period of approximately sixteen months.

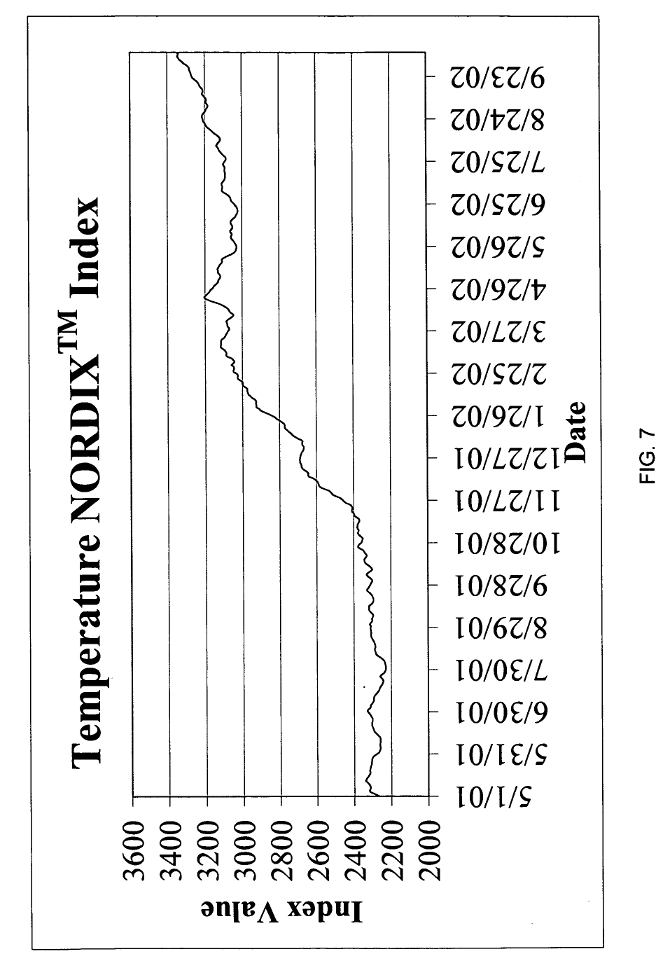

FIG. 7 is a graph, for exemplary purposes only, of a Precipitation NORDIX index covering approximately twelve years.

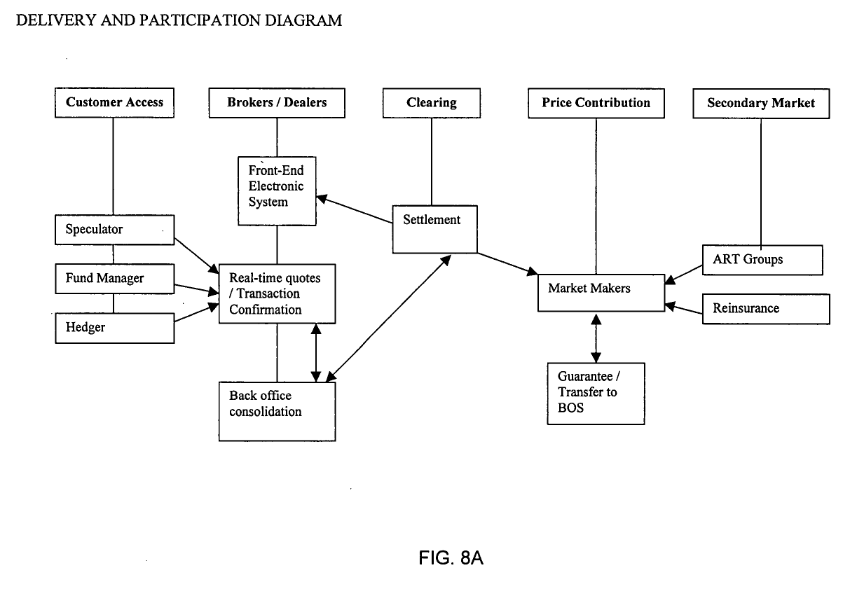

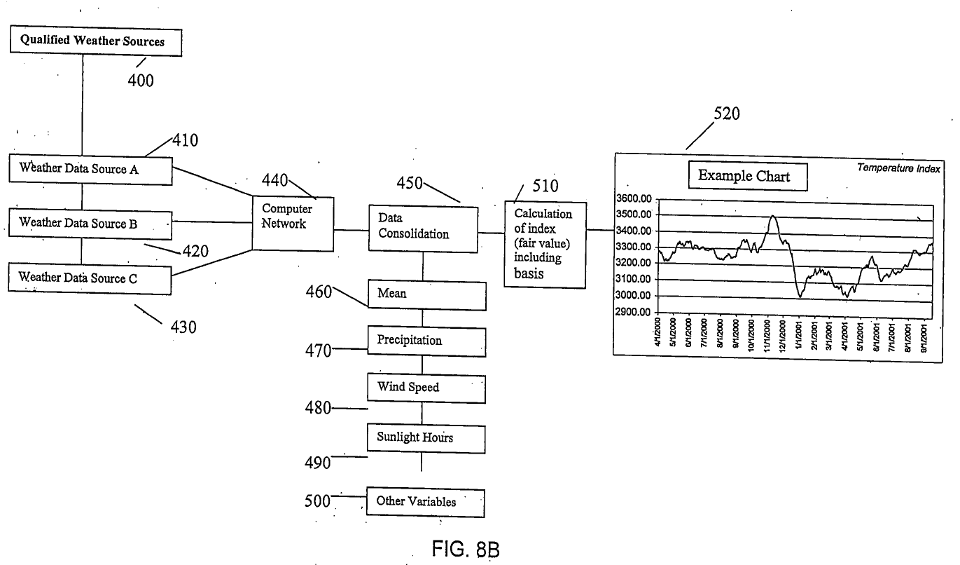

FIG. 8A charts, for exemplary purposes only, the flow of operations in the utilization of the NORDIX index by financial investors.

FIG. 8B charts the flow of data information used in compiling the NORDIX index. Data is obtained from qualified weather sources 400. Such data may be obtained from several different sources 410, 420, and 430. This data is then sent through computer network 440 and data undergoes a data consolidation 450 step. In this data consolidation 450 step, data for mean temperature 460, precipitation 470, wind speed 480, sunlight hours 490 and other variables 500 may be used. From these data, an index is calculated 510 including a basis value. Finally, data is output in the form of a numerical index and is plotted as shown in example chart 520.

Alternative embodiments based on any other weather variable may be computed in the same fashion and combined with a suitable basis or par value.

In a further alternate embodiment, a time specific weather pricing model is obtained by generating the pricing model from reported weather data, wherein two or more counterparties to a contract each utilize different data sources and independent analysis to price a financial contract by creating an indicator for determination of a consideration value or premium for risk coverage based on the data sources, and wherein the counterparties make their decision based on the pricing model.

In yet another alternate embodiment, historical weather data for a plurality of locations is combined and transformed into pricing models or schedules, and subsequently utilized in support of pricing and valuation of weather insurance policies, contracts and derivatives.

In an alternate embodiment of the present invention, financial derivative contracts could be evaluated for price and structure via pricing model components 600 following process flow diagram 700.

In still yet a further alternate embodiment of the present invention, a numerical indicator is established to promote universal pricing, transfer and valuation of financial contracts by providing risk coverage for weather measures and providing indemnification based on the weather measures, wherein the indemnification is independent of the actual loss, rather being settled based on a numerical indicator that comprises a deviation from historical values of the weather measures.

In another alternate embodiment of the present invention, a time specific weather pricing model is generated from reported current or delayed-current weather data, wherein two or more counterparties each utilize different data sources and independent analysis to agree on a price for a financial contract.

In yet still another alternate embodiment of the present invention, a weather-based financial contract made between at least two counterparties for insuring selected geographic locations against the occurrence of deviations from historical weather measures for a selected time duration. In this alternate embodiment, historical weather data is procured, the financial contract is priced to include coverage amount, terms and limitations, and the counterparties make their decision based upon a pricing model indicator derived from deviations of actual weather data from the historical weather data.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A method of determining a pricing model for weather financial contracts, said method comprising the steps of:
a. obtaining historical weather data;
b. analyzing said historical weather data; and
c. utilizing said historical weather data for use in creating at least one numeric indicator.

2. The method of claim 1, wherein said step of utilizing further comprises the steps of:
d. collecting current weather data; and
e. transforming said current weather data and said historical weather data into said at least one numeric indicator, wherein said at least one numeric indicator comprises a deviation of said current weather data from said historical weather data.

3. The pricing model of claim 2, further comprising the step of:
f. deriving said weather data from weather reporting sources.

4. The method of claim 3, further comprising the step of:
g. qualifying said historical weather data and said current weather data prior to incorporating said historical and current weather data into said pricing model.

5. The method of claim 1, wherein said financial contracts comprise insurance policies.

6. The method of claim 1, wherein said financial contracts comprise derivatives.

7. The method of claim 1, wherein said historical weather data is selected from the group consisting of precipitation data, humidity data, wind speed data, temperature data, sunshine hours data, a tradable weather index, and combinations thereof.

8. The method of claim 1, wherein said historical weather data is selected for a single location.

9. The method of claim 1, wherein said historical weather data is selected for a plurality of locations.

10. The method of claim 7, wherein said temperature data is selected from the group consisting of median temperature, actual temperature, high temperature, low temperature, average temperature, and combinations thereof.

11. The method of claim 7, wherein said precipitation data is selected from the group consisting of median precipitation, actual precipitation, average precipitation, high precipitation, low precipitation, and combinations thereof.

12. The method of claim 7, wherein said wind speed data is selected from a group consisting of high wind speed, low wind speed, actual wind speed, median wind speed, average wind speed, and combinations thereof.

13. The method of claim 7, wherein said sunshine hours data is selected from a group consisting of high sunshine hours, low sunshine hours, median sunshine hours, average sunshine hours, actual sunshine hours, and combinations thereof.

14. The method of claim 1, wherein said numeric indicator comprises actual deviations from weather data measures.

15. The method of claim 2, wherein said current weather data comprises data for a single location.

16. The method of claim 2, wherein said current weather data comprises data for a plurality of locations.

17. The method of claim 2, wherein said current weather activity data is obtained in real time.

18. The method of claim 2, wherein said current weather activity data is obtained in delayed time.

19. The method of claim 9, wherein said weather data for a plurality of locations is used in support of pricing and valuation of weather insurance policies, contracts and derivatives.

20. The method of claim 9, wherein said historical weather data for a plurality of locations is combined and transformed into at least one pricing model or schedule.

21. The method of claim 20, wherein said historical weather data is transparent to a user.

22. The method of claim 20, wherein said historical weather data is non-transparent to a user.

23. The method of claim 9, wherein said step of transforming comprises data that is independent of potentially manipulable components.

24. The method of claim 1, wherein said historical data is incorporated into an index.

25. A method of establishing a numerical indicator to promote universal pricing, transfer and valuation of financial contracts, said method comprising the step of:
a. providing risk coverage for weather measures; and
b. providing indemnification based on weather measures, wherein said indemnification is based on a numerical indicator comprising a deviation from historical values of said weather measures.

26. The method of claim 25, wherein said indemnification is independent of actual loss.

27. A process for generating a time specific weather pricing model, said process comprising the step of:
a. generating said pricing model from reported weather data, wherein counterparties each utilize different data sources and independent analysis to price a financial contract.

28. The process of claim 27, wherein said financial contract comprises a contract between at least two counterparties.

29. The process of claim 27, wherein said financial contract is an insurance policy contract.

30. The process of claim 28, further comprising the step of:
b. said at least two counterparties making a transaction decision based on said pricing model.

31. The process of claim 28, further comprising the step of:
b′. creating a indicator for determination of a consideration value for risk coverage.

32. The process of claim 31, wherein said consideration value comprises a premium.

33. A pricing model comprising:
a numerical indicator of deviation from weather measures, wherein said numerical indicator includes highs, lows, averages, actuals, and medians of said weather measures, and wherein said pricing model is utilized to determine pricing for weather-based financial contracts.

34. The pricing model of claim 33, wherein said numerical indicator is transparent to the user.

35. The pricing model of claim 33, wherein said numerical indicator is non-transparent to the user.

36. The pricing model of claim 33, wherein said financial contracts are insurance policy contracts, and wherein indemnification under said insurance policy contracts is based on weather measures that are independent of loss.

37. The pricing model of claim 33, wherein said financial contracts are weather derivatives.

38. The pricing model of claim 33, wherein said financial contracts are weather insurance policies.

39. The pricing model of claim 33, wherein said financial contracts are written for a specified time duration and with a specific expiration date.

40. A method of making a weather-based financial contract to insure selected geographic locations against the occurrence of deviations from historical weather measures for a selected time duration, said method comprising the steps of:
a. procuring historical weather data;
b. pricing said financial contract, wherein said financial contract includes coverage amount, terms and limitations; and
c. binding at least two counterparties.

41. The method of claim 40, wherein said financial contract further comprises a deductible limit based on historical deviations from normal historical values, and wherein said deductible limit must be exceeded for payout to occur.

42. The method of claim 41, wherein the amount of said historical deviations from said normal historical values is factored into a premium paid for said financial contract.
